(19) United States
(12) Patent Application Publication
(10) Pub. No.: US 2002/0104418 A1
(43) Pub. Date: Aug. 8, 2002

(54) Height adjustment mechanism for blade of bench saw

(76) Inventor: Chao Tang Chang, Taichung City (TW)

Correspondence Address: Keith Kline, PRO-TECHTOR INTERNATIONAL SERVICES, 20775 Norada Court, Saratoga, CA, 95070-3018, US

(21) Appl. No.: 09/777,496

(22) Filed: Feb. 5, 2001

(51) Int. Cl. B23D 45/06

(52) U.S. Cl. 83/477.1; 83/477.2

(57) ABSTRACT

A mechanism is mounted on a bench saw for adjusting the height of the blade of the bench saw. The bench saw includes an opening on the table, a first aperture on an inner side surface of the table facing the opening, a block fixed under the table and projected inwardly from the inner side surface of the table, a pivotal plate member sized to the opening so as to rest on the portion of the top surface of the block, and a slit on the pivotal plate member with a portion of the blade projected above. The adjustment mechanism comprises a second aperture on the side of the pivotal plate member facing the first aperture, a T-shaped groove adjacent and in communication with the second aperture, and a T-shaped member including a vertical trigger section and a horizontal bar section having a first end extended through the second aperture to receive in the first aperture and the other portion received in the horizontal part of the T-shaped groove in a locked position. The trigger section is operable to pull up and slide to cause the first end of the bar section to clear from the first aperture.

### FIELD OF THE INVENTION

The present invention relates to bench saw and more particularly to an mechanism for enabling user to adjust the height of the blade of the bench saw from above the table.

### BACKGROUND OF THE INVENTION

A conventional bench saw 10 is shown in FIG. 1 comprising a rectangular elongate slot 12 on the table 11 and a circular saw secured under table 11 having a portion of blade 13 projected above the slot 12. However, the previous design suffered from a disadvantage, i.e., user has to bend his/her back under table 11 to loosen a wing nut in order to adjust the projected area of blade 13. This is inconvenient. Thus, improvement exists.

### SUMMARY OF THE INVENTION

It is an object of the present invention to provide an adjustment mechanism mounted on a bench saw for adjusting the height of the blade of the bench saw, the bench saw including an opening on the table, a first aperture on an inner side surface of the table facing the opening, and a block fixed under the table having a portion of the top surface thereof projected inwardly from the inner side surface of the table, a pivotal plate member sized to the opening so as to rest on the portion of the top surface of the block, and a slit on the pivotal plate member with a portion of the blade projected above, the adjustment mechanism comprising a second aperture on the side of the pivotal plate member facing the first aperture, a T-shaped groove adjacent and in communication with the second aperture, and a T-shaped member including a vertical trigger section and a horizontal bar section having a first end extended through the second aperture to receive in the first aperture and the other portion received in the horizontal part of the T-shaped groove in a locked position. The trigger section is operable to pull up and slide to cause the first end of the bar section to clear from the first aperture.

The above and other objects, features and advantages of the present invention will become apparent from the following detailed description taken with the accompanying drawings.

### BRIEF DESCRIPTION OF THE DRAWINGS

FIG. 1 is a perspective view of a conventional bench saw;

FIG. 2 is a perspective view of a bench saw incorporating a height adjustment mechanism for blade according to the invention;

FIG. 3 is a greatly enlarged fragmentary view of the circled area A of FIG. 2;

FIG. 4 is a cross-sectional view taken along line 44 of FIG. 2;

FIG. 5 is a cross-sectional view where trigger member is pulled upright from second groove and the head of bar member is pushed to enter into first aperture in a locked state;

FIG. 6 is view similar to FIG. 5 where the head of bar member is pulled to clear from first aperture in an unlocked state;

FIG. 7 is perspective view showing a pulled up circular saw;

FIG. 8 is a side view in part section showing the height adjustment operation of blade; and

FIG. 9 is a cross-sectional view of a second embodiment of swingable joint according to the invention.

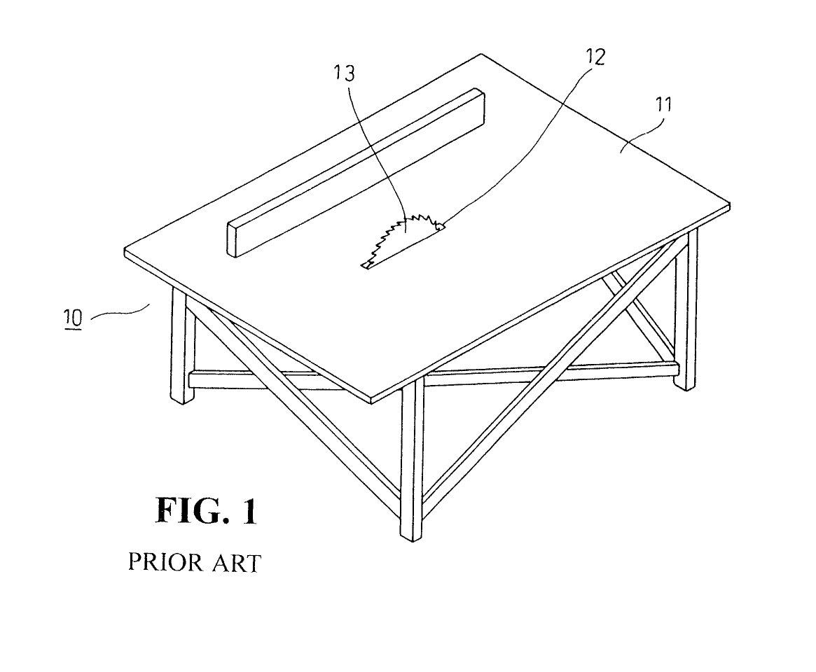

### DETAILED DESCRIPTION OF THE PREFERRED EMBODIMENTS

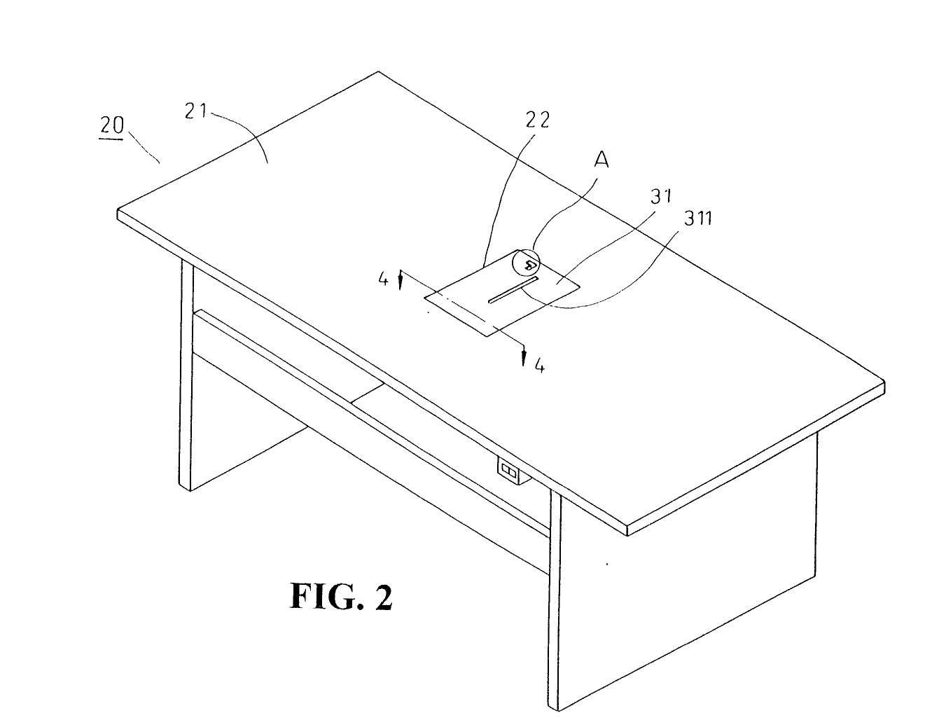

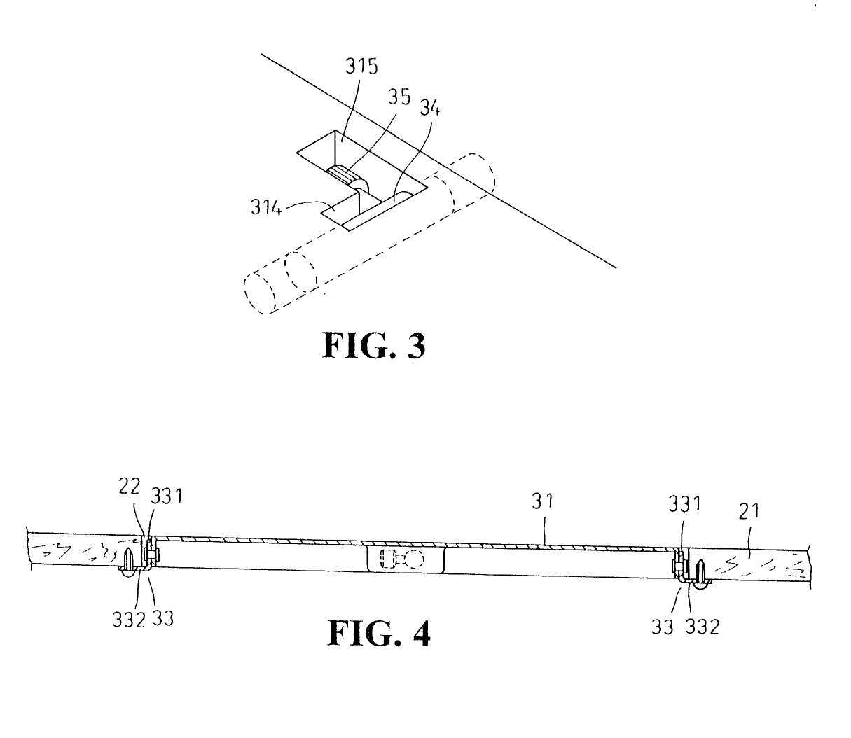

Referring to FIGS. 2 to 8, a bench saw 20 incorporating a blade height adjustment mechanism for blade 32 according to the invention is shown. A square opening 22 is provided on table 21. A first aperture 222 is provided on an inner side surface 221 of table 21 facing the opening 22. An elongate block 23 is provided below the joining of table 21 and a metal square pivotal plate member 31 of circular saw 30. Hence, a portion of pivotal plate member 31 may be rested on a top surface 231 of the block 23 in an operating or storage state. A rectangular elongate slot 311 is provided on the pivotal plate member 31 with a portion of blade 32 of circular saw 30 projected above. A pair of swingable joints 33 are provided each for pivotably coupling one of two comers of pivotal plate member 31 to an internal corner of table 21 formed by opening 22. Swingable joint 33 comprises a vertical portion 331 for coupling one of above two corners of pivotal plate member 31 to one of two internal corners of table 21 formed by opening 22 and a horizontal portion 332 for coupling the other comer of pivotal plate member 31 to the other internal corner of table 21 formed by opening 22. A second aperture 313 is provided on the side 312 of pivotal plate member 31 facing first aperture 222. A first groove 314 is formed adjacent the side 312 and is in communication with second aperture 313. A second groove 315 is formed integrally with first groove 314 to form an L-shaped groove. A T-shaped member comprises a bar member 34 including a threaded hole 341 and a trigger member 35 including a head 351 and a shank 352 having a lower threaded section being threadedly secured to the threaded hole 341. Bar member 34 in first groove 314 is slid to enter into first aperture 222, while trigger member 35 is reseted on second groove 315 in an operating or storage state (i.e., circular saw 30 is locked in opening 22).

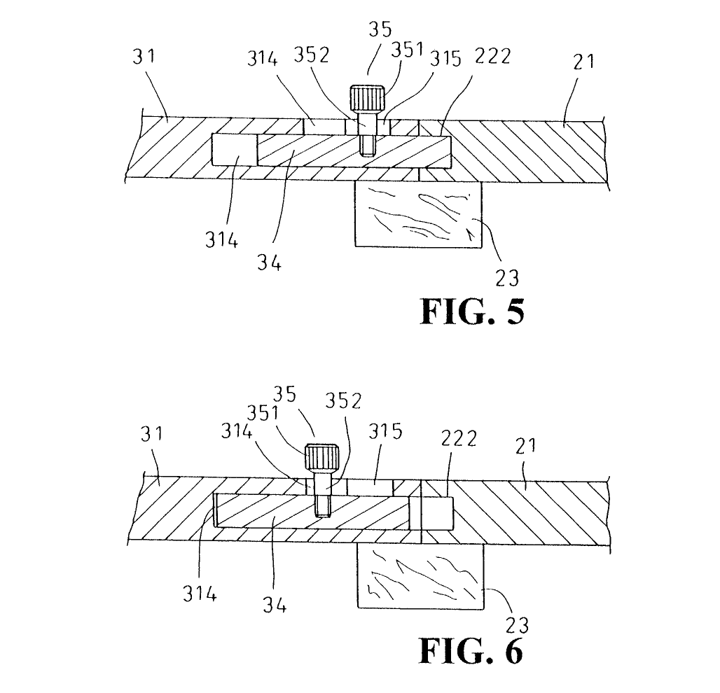

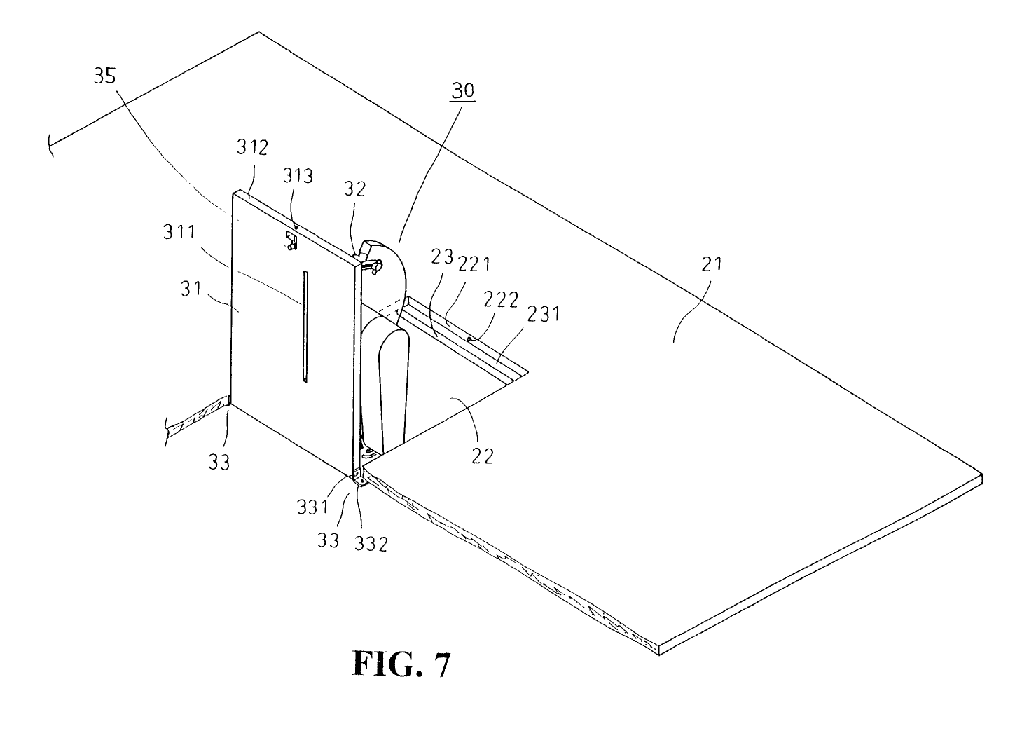

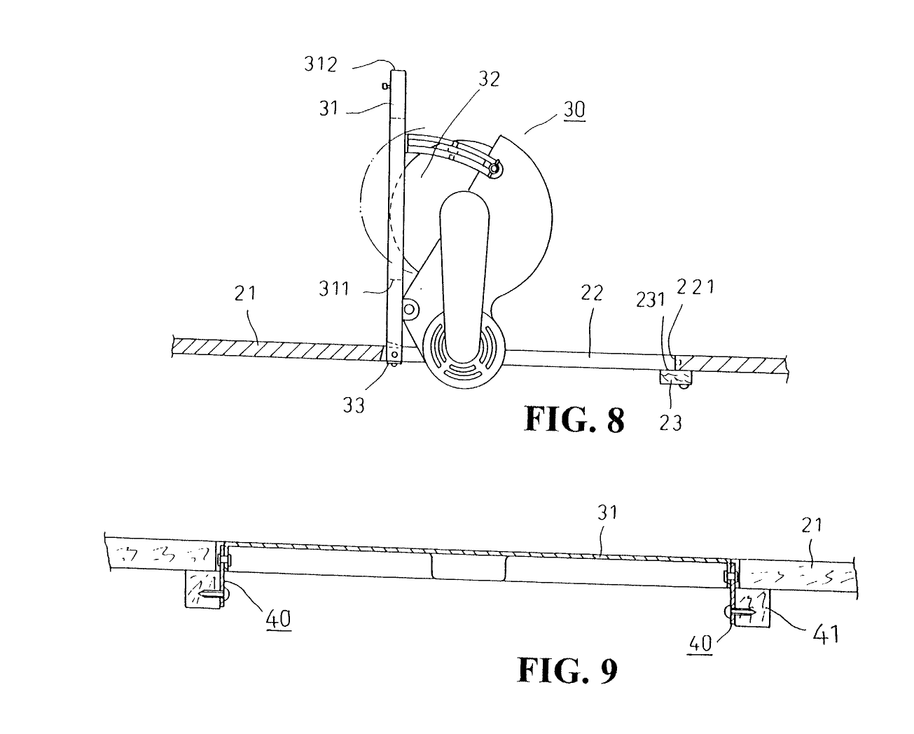

Referring to FIGS. 5 through 8 specifically, a description of the height adjustment of blade will now be described. First user may pull head 351 up and slide bar member 34 rearward to clear from first aperture 222 (FIGS. 5 and 6). At this time, the front side of pivotal plate member 31 is unlocked. Thus user may pull circular saw 30 up at an angle about 90 degrees with respect to table 20 (FIG. 7). Next user may adjust the height of blade 32 from above the table 20 (FIG. 8). This is more convenient as compared to prior art. When the adjustment is finished, a reverse procedure is simply performed to secure circular saw 30 to table 20 again.

Referring to FIG. 9, there is shown a second embodiment of swingable joint 40 according to the invention. This swingable joint 40 has an elongate shape. In installation, two blocks 41 each is provided under one of two internal corners of table 21 formed by opening 22. The lower portion of swingable joint 40 is fastened to the inner side of block 41, while the upper portion of swingable joint 40 is fastened to a comer of pivotal plate member 31.

While the invention herein disclosed has been described by means of specific embodiments, numerous modifications and variations could be made thereto by those skilled in the art without departing from the scope and spirit of the invention set forth in the claims.

What is claimed is:

1. A mechanism mountable on a bench saw for adjusting said height of said blade of said bench saw, said bench saw including an opening on said table, a first aperture on an inner side surface of said table facing said opening, a block fixed under said table having a portion of said top surface thereof projected inwardly from said inner side surface of said table, a plate member pivotably coupled to said table by a pair of hinge means and sized to said opening so as to rest on said portion of said top surface of said block, and a slit on said plate member with a portion of said blade projected above, said adjustment mechanism comprising:
a second aperture on said side of said plate member facing said first aperture,
a T-shaped groove adjacent and in communication with said second aperture; and
a T-shaped member including a vertical trigger section and a horizontal bar section having a first end extended through said second aperture to receive in said first aperture and said other portion received in said horizontal part of said T-shaped groove in a locked position;
wherein said trigger section is operable to pull up and slide to cause said first end of said bar section to clear from said first aperture.

2. The mechanism of claim 1, wherein each of said hinge means comprises a vertical portion coupled to said edge of said plate member and a horizontal portion coupled said edge of said opening.

3. The mechanism of claim 1, wherein said bar section comprises a threaded hole and said trigger section comprises a threaded section in said lower end being secured to said threaded hole.

4. The mechanism of claim 1, wherein each of said hinge means comprises a a block fixed under said table abutted said opening, an upper portion coupled to said edge of said plate member, and a lower portion coupled to said block.
